(19) United States
(12) Patent Application Publication
(10) Pub. No.: US 2016/0275451 A1
(43) Pub. Date: Sep. 22, 2016

(54) Methods and Systems for Managing Custodian Operations For an Electronic Contract Retained for an Organization

(71) Applicant: Adobe Systems Incorporated, San Jose, CA (US)

(72) Inventor: Benjamin David Follis, London (GB)

(73) Assignee: Adobe Systems Incorporated

(21) Appl. No.: 14/662,926

(22) Filed: Mar. 19, 2015

(51) Int. Cl. G06Q 10/10

(52) U.S. Cl. CPC G06Q 10/10

(57) ABSTRACT

Systems and methods for retaining contracts and managing custodian operations using a management server. One embodiment involves, in a computer network environment, managing custodian operations for an electronic contract retained for an organization. This embodiment involves retaining the electronic contract on the electronic contract server for the organization, wherein non-custodians are restricted from performing custodian operations on the electronic contract. The embodiment further involves creating a custodian identifier for the electronic contract, the custodian identifier unique for the contract and the organization. The embodiment further involves receiving a request to access the electronic contract for custodian operations, the request identifying the custodian identifier. The embodiment further involves providing the electronic contract for custodian operations, wherein the custodian operations that are allowed are determined based on the custodian identifier.

### TECHNICAL FIELD

This disclosure relates generally to computer-implemented methods and systems and more particularly relates to improving the efficiency and effectiveness of computing systems used in managing electronic contract storage and use.

### BACKGROUND

Many organizations are subject to severe penalties if records pertaining to financial transactions are not properly kept. For example, many large companies are subject to the United States Sarbanes-Oxley act, which imposes such penalties for failing to properly keep financial records. Contracts, by their nature, tend to fall under such scrutiny. However, contracts are frequently misplaced, or are difficult to gather when an audit is performed.

The introduction and use of electronic contracts has created additional unique problems with respect to ensuring that the electronic contracts are securely kept. The use of electronic contracts, for example, has made it easier and simpler for members of an organization to enter into contracts on behalf of the organization but then fail to properly register (or otherwise provide a copy) with their organization's record keeping department. Additionally, organizations frequently have internal tracking references that are not properly associated with electronic contracts, making automated or manual auditing difficult and impractical. Existing techniques for using electronic contracts often result in contracts that are created and then not registered with and not effectively managed by the organization's record keeping department.

### SUMMARY

Systems and methods are disclosed herein for retaining contracts and managing custodian operations using a management server. One embodiment involves, in a computer network environment, managing custodian operations for an electronic contract retained for an organization. This embodiment involves retaining the electronic contract on an electronic contract server for the organization, where non-custodians are restricted from performing custodian operations on the electronic contract. The embodiment further involves creating a custodian identifier for the electronic contract, the custodian identifier unique for the contract and the organization. The embodiment further involves receiving a request to access the electronic contract for custodian operations, the request identifying the custodian identifier. The embodiment further involves providing the electronic contract for custodian operations, wherein the custodian operations that are allowed are determined based on the custodian identifier.

Systems and methods are disclosed herein for managing custodian operations for an electronic contract retained for multiple organizations. One embodiment involves, in a computer network environment, managing custodian operations for an electronic contract retained for multiple organizations. This embodiment involves retaining the electronic contract on the electronic contract server for the organizations, where non-custodians are restricted from performing custodian operations on the electronic contract. This embodiment further involves receiving a request to access the electronic contract for a custodian operation on behalf of a first organization. The embodiment further involves identifying that performing the custodian operation conflicts with a policy specified by another organization. The embodiment further involves performing the custodian operation based on resolving the conflict.

These illustrative embodiments and features are mentioned not to limit or define the disclosure, but to provide examples to aid understanding thereof. Additional embodiments are discussed in the Detailed Description, and further description is provided there.

### BRIEF DESCRIPTION OF THE FIGURES

These and other features, embodiments, and advantages of the present disclosure are better understood when the following Detailed Description is read with reference to the accompanying drawings.

FIG. 1 is a block diagram depicting an example of a system for retaining contracts and managing custodian operations using a management server.

FIG. 2 is a block diagram illustrating exemplary modules for implementing functions in the management server of FIG. 1.

FIG. 3 is a flow chart of an exemplary method for managing custodian operations for an electronic contract retained for an organization.

FIG. 4 is a flow chart of another exemplary method for managing custodian operations for electronic contracts retained for an organization.

FIG. 5 is a flow chart of an exemplary method of ensuring that electronic contracts are identified for custodian review.

FIG. 6 is a flow chart of an exemplary method for managing custodian operations for an electronic contract retained for multiple organizations.

FIG. 7 is a flow chart of an exemplary method for auditing custodian behaviors with respect to electronic contracts.

FIG. 8 is a block diagram depicting example hardware implementations for the components described in FIG. 1.

### DETAILED DESCRIPTION

Existing techniques for using electronic contracts often result in contracts that are created and then not registered with and not effectively managed by the organization's record keeping department. This invention addresses these issues using a computer system that manages custodian operations of electronic contracts. Specifically, the system retains the electronic contract and allows only a designated custodian or custodians to access the electronic contract to perform custodian operations (e.g., verifying that the contract is intact, expunging the contract, etc.). In one embodiment, for each electronic contract, a custodian identifier is created that is unique for the electronic contract and the organization. This allows only an appropriate custodian to access the electronic contract to perform the custodian operations.

In one embodiment, the system is combined with, or interfaces with, an electronic signature service that is used to create the electronic contracts. A link between the electronic signature service used to create the contract and the system used to manage custodian operations ensures that custodian operation management system is aware of, and therefore able to manage, all of the created electronic contracts for the organization. It ensures that no contracts are overlooked inadvertently. In one example, an organization identifies an appropriate individual, group, or other component of the organization as a custodian of records for all contracts of the organization. Different types of contracts may be assigned different custodians. When a new contract is created, custodian management information, such as a custodian identifier, is created to ensure that the contract is visible to, and therefore will be tracked and managed by, an appropriate custodian. The association generally ensures that all of the electronic contracts' retention, visibility, and audit information is subject to the organization's internal record keeping policies.

A given electronic contract can be stored for multiple organizations. For example, two parties may enter into an electronic contract and the electronic contract may be maintained on behalf of both parties. As a specific example, a landscaping organization may enter into an electronic contract with an organization that operates a shopping center to maintain the landscaping around the buildings of the shopping center. The electronic contract is maintained on behalf of each organization, i.e., on behalf of both the landscaping organization and the organization that operates the shopping center. Custodian identifiers are created for each organization. In this example, a first custodian identifier is created identifying the electronic contract and the landscaping organization and a second custodian identifier is created identifying the electronic contract and the organization that operates the shopping center. Custodians at each of the organizations uses their organization's respective custodian identifier to access the electronic contract to perform custodian operations.

The system can also manage conflicts between multiple organizations relative to a given electronic contract. For example, if one organization's custodian attempts to expunge an electronic contract, the system ensures that this expungement is acceptable to the other organization's custodian, delays the expungement until acceptable to all, or takes other conflict resolution action. Management of custodian operations for an electronic contract for multiple organizations at a centralized, independent service in this way can reduce or eliminate the time and effort required to address such conflicts.

These illustrative examples are given to introduce the reader to the general subject matter discussed here and are not intended to limit the scope of the disclosed concepts. The following sections describe various additional aspects and examples with reference to the drawings in which like numerals indicate like elements, and directional descriptions are used to describe the illustrative examples but, like the illustrative examples, should not be used to limit the present disclosure.

As used herein, the phrase “electronic contract” refers to an electronically-stored or electronically-captured document or recording that represents or records a contract involving one or more parties. Electronic contracts may take the form of text, images, sounds, or videos stored in electronic document files, audio recordings, video recordings, or any other suitable electronic form.

As used herein, the phrase “organization” refers to any corporation, partnership, cooperative, business, business unit, university, school, institution, association, government, agency, charity, or other entity that has a collective goal or is otherwise associated.

As used herein, the phrase “custodian” refers to a person, group, or entity responsible for or that looks after an electronic contract on behalf of an organization. An electronic contract can have multiple custodians within a given organization. For example, if an electronic contract relates to both operations in France and operations in the United States, the electronic contract may have a French custodian and a U.S. custodian.

As used herein, the phrase “custodian operations” refers to any function performed by a custodian in looking after an electronic contract. Examples of custodian operations include, but are not limited to, ensuring that an electronic contract is still intact and expunging an electronic contract.

As used herein, the phrase “electronic signature service” refers to a service used to execute an electronic contract by one or more parties to the electronic contract. An electronic signature service may send electronic messages to the parties of the contract and/or provide a user interface that the parties and other entities can use to access the contract for review, execution, or otherwise. An electronic signature service may be independent of the parties to the electronic agreement.

As used herein, the phrase “independent” refers to something not being controlled or owned by a person or entity who is a party to an electronic contract. An independent server, for example, is controlled by a third party who is not directly involved in the electronic contract transaction. For example, if there are two parties to an electronic contract, a server is independent if operated by a third party who is not one of the two parties and not owned or controlled by either of the two parties.

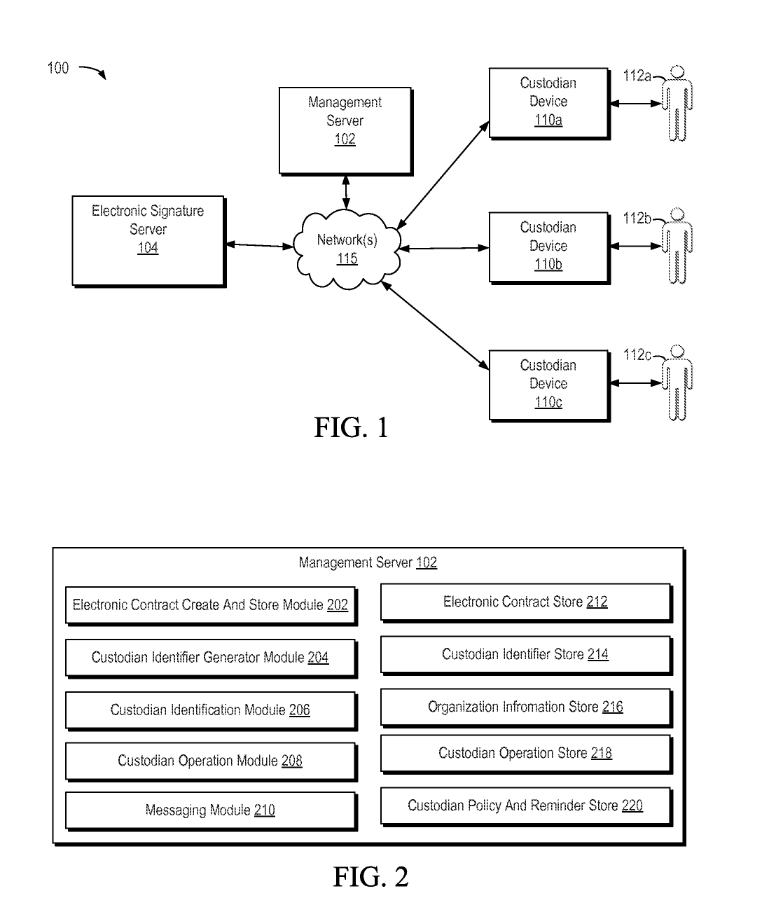

Referring now to the drawings, FIG. 1 is a block diagram depicting an example of a system for retaining contracts and managing custodian operations using management server 102. Management server 102 interacts with remote computing devices over network 115. Management server 102 stores electronic contracts and performs custodian operation management functions. In one embodiment, electronic contracts are received from a remote source, such as from electronic signature service 104. In this example, electronic signature service 104 is used to obtain signatures from contract participants to facilitate execution of an electronic contract. In one embodiment, a single, independent third party entity operates both management server 102 and the electronic signature server 104, which may be combined within a single device, to facilitate both the formation of electronic contracts, the retention of electronic contracts, and the management of custodian operations on the retained contracts.

The management server 102 allows custodians 112a-c using custodian devices 110a-c to perform custodian operations on electronic contracts managed by the management server 102. For example, the management server 102 may retain an electronic contract and create a custodian identifier for the electronic contract that allows custodian 112a to access the electronic contract to perform custodian operations on behalf of an organization identified by the custodian identifier. The management server 102 receives requests to access the electronic contract for custodian operations from the custodian and identifies custodian operations that are permitted for the custodian based on the custodian identifier.

The management server 102 also sends reminders to custodians regarding upcoming custodian obligations. In one example, the management server 102 identifies a custodian review schedule requiring that the custodian access an electronic contract every six months and sends an electronic message to the custodian reminding the custodian of upcoming review obligations.

In another example, the management server 102 provides a custodian-specific user interface that provides custodian specific tools. Exemplary tools identify electronic contracts that are coming due for review, identify electronic contracts coming due for expungement according to an expungement policy, identify new contracts, identify custodian events for individual contracts that have been performed, and identify electronic contracts designations or classifications, e.g., contracts designated for special scrutiny.

FIG. 2 is a block diagram illustrating exemplary modules for implementing functions in server 102 of FIG. 1. Server 102 includes modules 202, 204, 206, 208, 210 which each are implemented by a processor executing stored computer instructions, and stores 212, 214, 216, 218, and 220 which store information on a non-transitory computer-readable medium. The electronic contract create and store module 202 creates and stores electronic contracts and associated metadata. In one embodiment, the electronic contract create and store module 202 creates the electronic contract as part of an electronic signature service used to obtain electronic signatures from the parties of the contract. In this example, information about how the contract will be stored and about how custodian operations will be managed is obtained as part of the contract creation process through the electronic signature service. In another embodiment, the electronic contract create and store module 202 receives an electronic contract from a separate system. For example, a custodian may upload a contract. However created, the electronic contract create and store module 202 stores the electronic contracts in the electronic contract store 212.

Custodian identifier generator module 204 generates custodian identifiers that are stored in custodian identifier store 214. Custodian identifiers are used to uniquely associate an electronic contract with an organization and/or a particular custodian. In one example, the custodian identifier identifies (implicitly or explicitly) the electronic contract and the organization for which the custodian records will apply and, based on the organization, an appropriate individual or group who will act as custodian is identified. Custodian identification module 206, for example, can use organization information store 216 to identify a designated custodian or custodian for an organization. In one example, a user accesses the management server 102 to perform custodian operations on an electronic contract. The user uses the custodian identifier, which identifies the electronic contract and the organization, and then logs in using user specific credentials. The management server 102 custodian identification module 206 identifies that the user is a custodian for the organization and authenticates the user using user supplied log in credentials.

Custodian operation module 208 performs the custodian operations on the electronic contract. For example, custodian operation module 208 can be used by a custodian to verify that an electronic contract is still intact or to expunge the electronic contract. Custodian operations can be tracked in custodian operation store 218 so that an organization retains a record of custodian operations that were performed, by whom the operations were performed, and when the operations were performed. The information in the custodian operation store 218 can be compared with information in a custodian policy and reminder store 220 to ensure that the organization's retention and custodian policies are complied with by the custodian. For example, the comparison may identify that a particular electronic contract has not been reviewed in over a year in violation of the organization's review policy. In response to this identification, the messaging module 210 can send a reminder to the custodian associated with the electronic contract or to an appropriate supervisor within the organization. Similarly, if a rouge custodian begins attempting to perform custodian operations in an manner that violates the organization's policies or is otherwise inconsistent with an expected behavioral pattern, the messaging module 210 can alert supervisory persons within the organization of the possibly inappropriate actions.

### Exemplary Custodian Operation Management Techniques

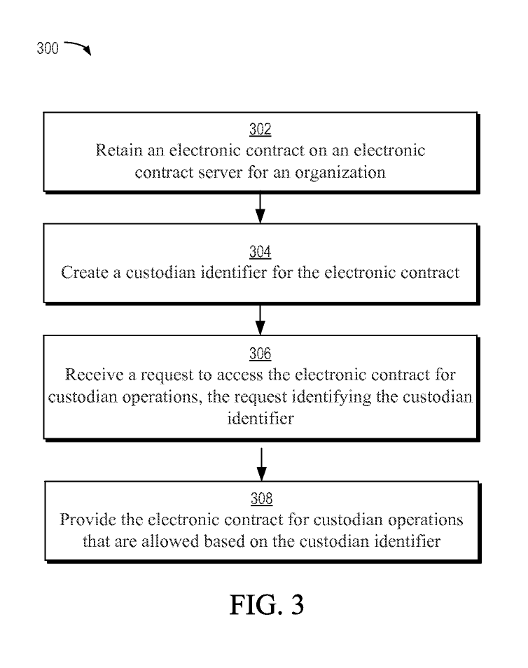

FIG. 3 is a flow chart of an exemplary method 300 for managing custodian operations for an electronic contract retained for an organization. Method 300 can be performed by server 102 of FIG. 1 or any other suitable device. Method 300 involves retaining the electronic contract on the electronic contract server for the organization, as shown in block 302. In one embodiment, this involves restricting non-custodians from performing custodian operations on the electronic contract. In one embodiment, one or more custodians are identified based on user input. In another embodiment, one or more custodians are identified based on a classification of the electronic contract. For example, a classification of the electronic contract may be determined based on a text analysis, video analysis, audio analysis, or other content analysis of the electronic contract and a custodian determined based on the classification. An organization, for example, may have specified that all contracts relating to one business unit are assigned to a first custodian while all contracts relating to a second business unit are assigned to a different custodian. Contract classifications can be based on various factors including, but not limited to, the language of the electronic contract (e.g., English, French, Spanish, Russian, etc.), the law governing the electronic contract, the geographic location associated with the electronic contract, and the business function associated with the electronic contract.

Method 300 further involves creating a custodian identifier for the electronic contract, as shown in block 304. In one example, the custodian identifier is unique for the contract and the organization. In another example, the custodian identifier is unique for the contract, the organization, and an individual acting as custodian of the electronic contract for the organization. Alternatively, an individual or group that will act as the custodian is determined based on the organization associated with the custodian identifier.

The method 300 involves receiving a request to access the electronic contract for custodian operations, the request identifying the custodian identifier, as shown in block 306. The request may include login credentials for a particular custodian associated with the organization. The request can be based on a user interacting with an interface, through a message, through an application programming interface call, or through any other computer based access mechanism.

The method 300 involves providing the electronic contract for custodian operations allowed based on the custodian identifier, as shown in block 308. Exemplary custodian operations include, but are not limited to, expunging the electronic contract on the electronic contract server and reviewing the electronic contract to ensure that the contract is intact. Providing the electronic contract for custodian operations can involve providing an interface for accessing the electronic contract to perform the custodian operations. Different custodians can have different custodian access privileges. For example, one custodian may he able to ensure that the contract is intact and another custodian may be able to both ensure that the contract is intact and expunge the contract.

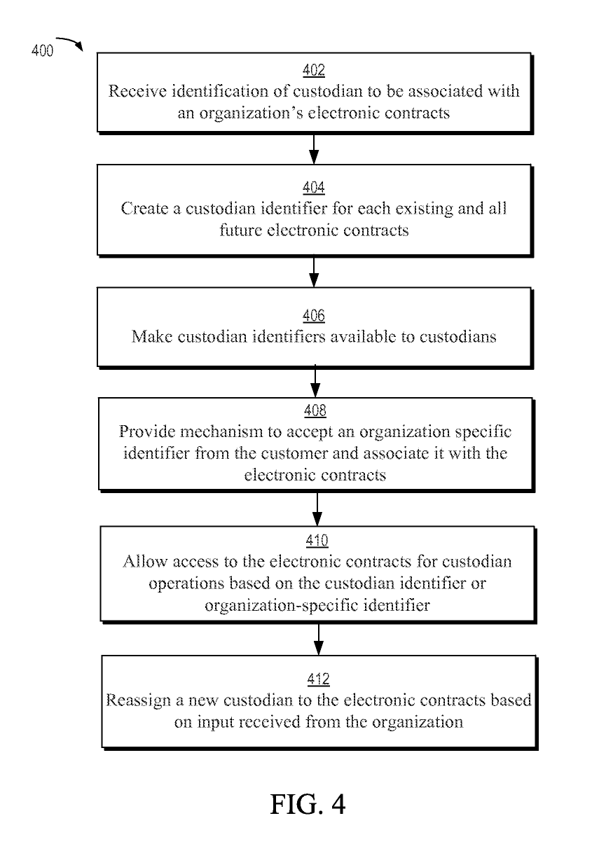

FIG. 4 is a flow chart of another exemplary method 400 for managing custodian operations for electronic contracts retained for an organization. Method 400 can be performed by server 102 of FIG. 1 or any other suitable device. Method 400 involves receiving an identification of a custodian to be associated with an organization's electronic contracts, as shown in block 402. In one embodiment, an organization designates one or more members of the organization as custodians for all of its contract, or for all of its contracts within a certain classification. Identification of a custodian can be received through a user interface, by application programming interface, telephone customer service, or via any other appropriate technique.

Method 400 further involves creating a custodian identifier for each existing and all future contracts of the organization, as shown in block 404. For every existing and future contract associated with the custodian, a unique, un-forgeable, and un-guessable identifier is created. Method 400 further involves making the custodian identifiers available to the custodian(s), as shown in block 406. In one example, when a new contract is created and a custodian identifier created, the custodian identifier is sent via electronic message to the custodian. Method 400 next involves providing a mechanism to accept an organization specific identifier from the customer and associate it with the electronic contracts, as shown in block 408. This allows custodians the flexibility to refer to electronic contracts using their own numbering system. Method 400 next involves allowing access to the electronic contracts for custodian operations based on the custodian identifier or organization-specific identifier, as shown in block 410.

Method 400 also involves reassigning a new custodian to the electronic contracts based on input received from the organization, as shown in block 412. This may occur, for example, when an employee acting as custodian leaves the organization and a new custodian needs to be assigned. Reassigning a new custodian to the electronic contract can involve creating new custodian identifiers and terminating access to the electronic contracts via the old custodian identifiers.

The custodian associated with one or more of an organization's electronic contracts can be notified in various circumstances. In one embodiment, a custodian is notified based on a change to the electronic contract, an upcoming expungement of the electronic contract, or a recurring task to confirm that the electronic contract is intact.

One embodiment involves receiving commands or push data to a record keeping service maintained by an organization. The organization may designate a record keeping service as the custodian or may allow their custodians to proxy their commands through their internal service. In this manner, the organization may integrate the contract with their internal record keeping systems or processes.

### Exemplary Interactions Between Electronic Signature Service and Custodian Management

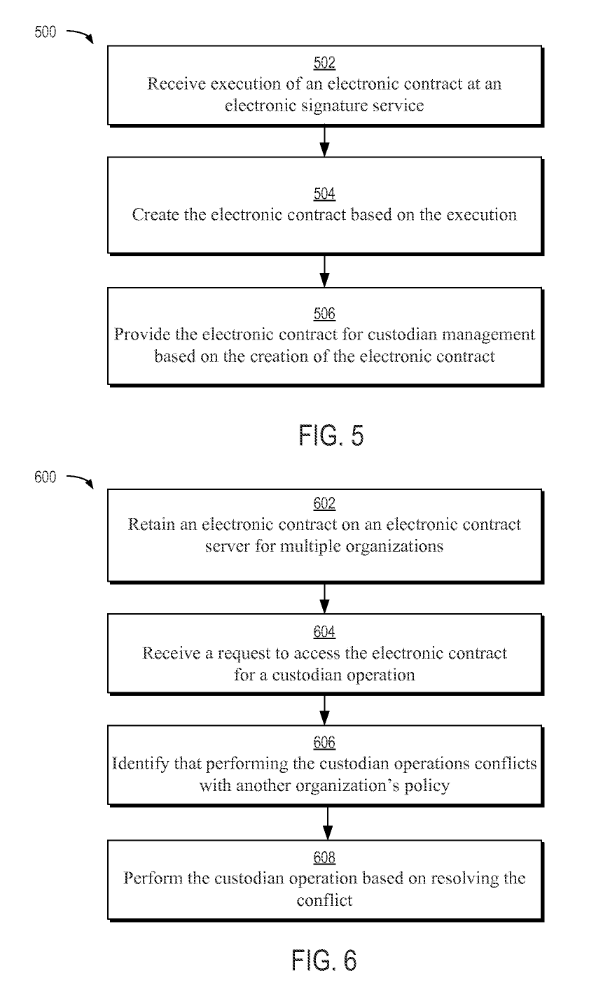

FIG. 5 is a flow chart of an exemplary method 500 of ensuring that electronic contracts are identified for custodian review. Method 500 can be performed by server 102 of FIG. 1 or any other suitable device. Method 500 involves receiving execution of the electronic contract at an electronic signature service, as shown in block 502, and creating the electronic contract based on the execution, as shown in block 504. Creation of the electronic contract then triggers providing the electronic contract for custodian management, as shown in block 506. Providing the electronic contract for custodian management as part of the electronic contract workflow provides various efficiencies, assurances, and other advantages. For example, doing so can reduce or eliminate the risk that a contract will be created and not reported to the organization's record keeping for custodian management.

The electronic signature service and custodian management services may be provided by a single entity or by multiple entities. In one example, electronic signature services and custodian management services are provided by a single server. In another example, an electronic signature service sends messages to a separate custodian management service to identify the creation of each new electronic contract for an organization. Such messages can be sent via any suitable electronic transmission and utilize any appropriate form.

### Exemplary Techniques for Managing Custodian Conflicts

FIG. 6 is a flow chart of an exemplary method 600 for managing custodian operations for an electronic contract retained for multiple organizations. Method 600 can be performed by server 102 of FIG. 1 or any other suitable device. Method 600 involves retaining an electronic contract on an electronic contract server for multiple organizations, as shown in block 602. In one embodiment this involves restricting non-custodians from performing custodian operations on the electronic contract. The method 600 further involves receiving a request to access the electronic contract for a custodian operation, as shown in block 604. Such a request may identify a particular custodian operation such as expungement of the electronic contract.

The method 600 further involves identifying that performing the custodian operations conflicts with another organization's policy, as shown in block 606. For example, the other organization's policy may require permission of other organization's custodians prior to any contract being expunged. As another example, the other organization's policy may require that all contracts be retained without expungement for at least a minimum time period, e.g., five years from execution, 1 year from expiration, according to a referenced legal retention policy or government requirement, etc.

The method 600 further involves performing the custodian operation based on resolving the conflict, as shown in block 608. This can involve performing the custodian operation in accordance with obtaining permission of the second custodian as required by the second custodian's policy. For example, if a first organization's custodian requests that an electronic contract be expunged, the other organization's custodian can be contacted for approval prior to expunging the contract. In one embodiment, an organization specifies a custodian policy. For example, the organization may specify a time constraint that the electronic contract cannot be expunged until a time requirement is satisfied, e.g., a policy that no electronic contract can be expunged for 5 years after execution of the respective electronic contract. If the other organization attempts to expunge the contract prior to five years being up, the system can notify the requesting organization that the expungement cannot be completed or will be delayed until the end of the five years required by the other organization's policy.

### Exemplary Techniques for Auditing Custodian Behaviors

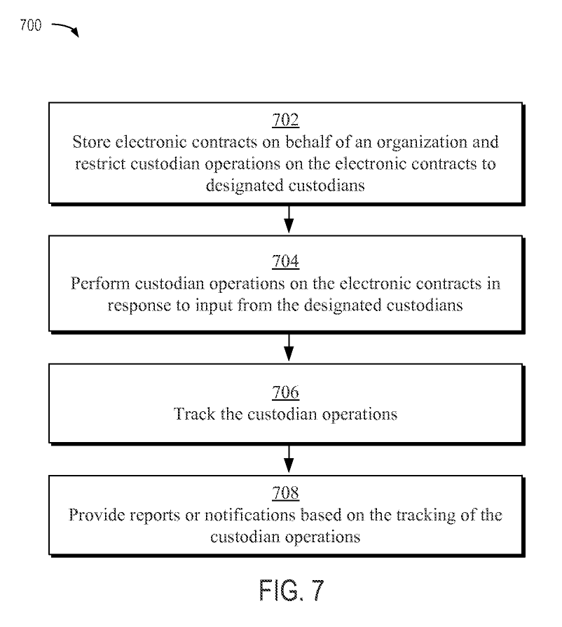

FIG. 7 is a flow chart of an exemplary method 700 for auditing custodian behaviors with respect to electronic contracts. Method 700 can be performed by server 102 of FIG. 1 or any other suitable device. Method 700 involves storing electronic contracts on behalf of an organization and restricting custodian operations on the electronic contracts to designated custodians, as shown in block 702.

The method 700 further involves performing custodian operations on the electronic contracts in response to input from the designated custodians, as shown in block 704, and tracking the custodian operations, as shown in block 706. Information about the operations can be stored, for example, in a database or in metadata associated with the electronic contracts. For example, each time an electronic contract is reviewed, metadata can be added to the electronic file in which the content of the electronic contract is stored.

The method 700 further involves providing reports or notifications based on the tracking of the custodian operations, as shown in block 708. One embodiment involves tracking whether a custodian performs recurring tasks of confirming that the electronic contract is intact. If a custodian does not perform a custodian task then an agent of the organization can be notified so that corrective actions can be taken. Similarly, if a custodian attempts to perform a custodian task in a manner inconsistent with an expectation, an agent of the organization can be notified. In one embodiment, a custodian management service provides reports or responds to queries on the actions of custodians. Such reports may be performed via application programming interface, user interface, or any other appropriate method.

### Exemplary Computing Environment

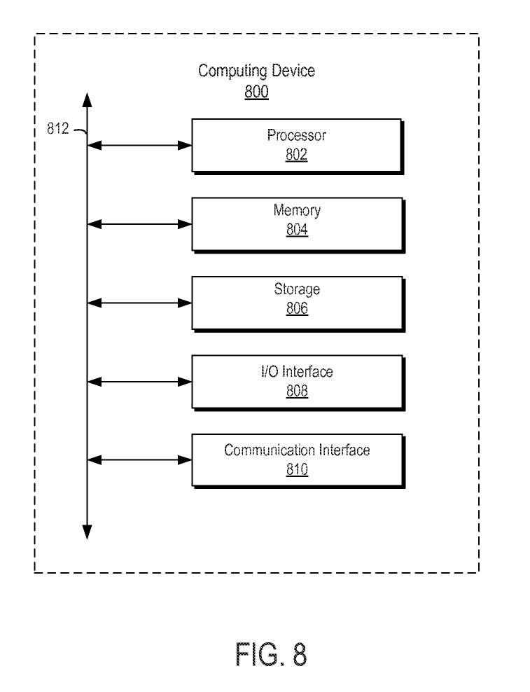

Any suitable computing system or group of computing systems can be used to implement the computer devices 102, 104, 110a-c of FIG. 1 or otherwise used to implement the techniques and methods disclosed herein. For example, FIG. 8 is a block diagram depicting examples of implementations of such components. The computing device 800 can include a processor 802 that is communicatively coupled to a memory 804 and that executes computer-executable program code and/or accesses information stored in the memory 804 or storage 806. The processor 802 may comprise a microprocessor, an application-specific integrated circuit (“ASIC”), a state machine, or other processing device. The processor 802 can include one processing device or more than one processing device. Such a processor can include or may be in communication with a computer-readable medium storing instructions that, when executed by the processor 802, cause the processor to perform the operations described herein.

The memory 804 and storage 806 can include any suitable non-transitory computer-readable medium. The computer-readable medium can include any electronic, optical, magnetic, or other storage device capable of providing a processor with computer-readable instructions or other program code. Non-limiting examples of a computer-readable medium include a magnetic disk, memory chip, ROM, RAM, an ASIC, a configured processor, optical storage, magnetic tape or other magnetic storage, or any other medium from which a computer processor can read instructions. The instructions may include processor-specific instructions generated by a compiler and/or an interpreter from code written in any suitable computer-programming language, including, for example, C, C++, C#, Visual Basic, Java, Python, Perl, JavaScript, and ActionScript.

The computing device 800 may also comprise a number of external or internal devices such as input or output devices. For example, the computing device is shown with an input/output (“I/O”) interface 808 that can receive input from input devices or provide output to output devices. A communication interface 810 may also be included in the computing device 800 and can include any device or group of devices suitable for establishing a wired or wireless data connection to one or more data networks. Non-limiting examples of the communication interface 810 include an Ethernet network adapter, a modem, and/or the like. The computing device 800 can transmit messages as electronic or optical signals via the communication interface 810. A bus 812 can also be included to communicatively couple one or more components of the computing device 800.

The computing device 800 can execute program code that configures the processor 802 to perform one or more of the operations described above. The program code can include one or more of the modules of FIG. 2. The program code may be resident in the memory 804, storage 806, or any suitable computer-readable medium and may be executed by the processor 802 or any other suitable processor. In some embodiments, modules can be resident in the memory 804. In additional or alternative embodiments, one or more modules can be resident in a memory that is accessible via a data network, such as a memory accessible to a cloud service.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure the claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art.

What is claimed is:

1. In a computer network environment, a method for managing custodian operations for an electronic contract retained for an organization, the method comprising an electronic contract server:
retaining the electronic contract on the electronic contract server for the organization, wherein non-custodians are restricted from performing custodian operations on the electronic contract;
creating a custodian identifier for the electronic contract, the custodian identifier unique for the contract and the organization;
receiving a request to access the electronic contract for custodian operations, the request identifying the custodian identifier; and
providing the electronic contract for custodian operations, wherein the custodian operations that are allowed are determined based on the custodian identifier.

2. The method of claim 1 wherein the custodian identifier is unique for the contract, the organization, and an individual acting as custodian of the electronic contract for the organization.

3. The method of claim 1 further comprising:
determining an individual as a custodian based on the organization associated with the custodian identifier; and
receiving login information confirming that the request is from the individual who is the custodian.

4. The method of claim 1 further comprising receiving execution of the electronic contract at an electronic signature service, wherein the electronic contract is retained on the electronic contract server for the organization based on input received at the electronic signature service.

5. The method of claim 1 further comprising:
performing a content analysis of the electronic contract to determine a classification of the contract; and
determining a custodian for the electronic contract based on the classification.

6. The method of claim 5 wherein the classification is based on one or more of:
language of the electronic contract;
applicable law of the electronic contract;
geographic location associated with the electronic contract; or
business function associated with the electronic contract.

7. The method of claim 1 wherein the custodian operations comprise expunging the electronic contract from the electronic contract server.

8. The method of claim 1 wherein the custodian operations comprise reviewing the electronic contract via the electronic contract server to ensure that the contract is intact.

9. The method of claim 1 wherein providing the electronic contract for custodian operations comprises providing an interface for accessing the electronic contract to perform the custodian operations.

10. The method of claim 1 further comprising notifying a custodian associated with the organization based on a change to the electronic contract, an upcoming expungement of the electronic contract, or a recurring task to confirm that the electronic contract is intact.

11. The method of claim 1 further comprising tracking whether a custodian performs recurring tasks of confirming that the electronic contract is intact.

12. The method of claim 1 further comprising:
identifying that a custodian did not perform a custodian task; and
notifying an agent of the organization that the custodian did not perform the custodian task.

13. The method of claim 1 further comprising:
identifying that a custodian is attempting to perform a custodian task in a manner inconsistent with an expectation; and
notifying an agent of the organization of the custodian attempting to perform the custodian task in the manner inconsistent with the expectation.

14. In a computer network environment, a method for managing custodian operations for an electronic contract retained for multiple organizations, the method comprising an electronic contract server:
retaining the electronic contract on the electronic contract server for the organizations, wherein non-custodians are restricted from performing custodian operations on the electronic contract;
receiving a request to access the electronic contract for a custodian operation on behalf of a first organization;
identifying that performing the custodian operations conflicts with a policy specified by another organization; and
performing the custodian operation based on resolving the conflict.

15. The method of claim 14 wherein the custodian operation involves expunging the electronic contract and performing the custodian operation comprises obtaining permission from a second custodian of the another organization to expunge the electronic contract.

16. The method of claim 14 wherein performing the custodian operation comprises delaying the custodian operation until a time constraint of the another organization is satisfied.

17. The method of claim 16 wherein the time constraint specifies that the electronic contract cannot be expunged until a time requirement is satisfied.

18. A system comprising:
a processing device; and
a memory device communicatively coupled to the processing device,
wherein the processing device is configured to execute instructions included in the memory device to perform operations comprising:
retaining the electronic contract on the electronic contract server for the organization, wherein non-custodians are restricted from performing custodian operations on the electronic contract;
creating a custodian identifier for the electronic contract, the custodian identifier unique for the contract and the organization;
receiving a request to access the electronic contract for custodian operations, the request identifying the custodian identifier; and
providing the electronic contract for custodian operations, wherein the custodian operations that are allowed are determined based on the custodian identifier.

19. The system of claim 18 wherein the custodian identifier is unique for the contract, the organization, and an individual acting as custodian of the electronic contract for the organization.

20. The system of claim 18 wherein the operations further comprise:
determining an individual as a custodian based on the organization associated with the custodian identifier; and
receiving login information confirming that the request is from the individual who is the custodian.
